(19) United States
(12) Patent Application Publication
(10) Pub. No.: US 2015/0183005 A1
(43) Pub. Date: Jul. 2, 2015

(54) SUBSTRATE CLEANING DEVICE

(71) Applicant: SHENZHEN CHINA STAR OPTOELECTRONICS TECHNOLOGY CO., LTD., Shenzhen, Guangdong (CN)

(72) Inventor: Meina Zhu, Shenzhen (CN)

(21) Appl. No.: 14/235,795

(22) PCT Filed: Jan. 7, 2014
(86) PCT No.: PCT/CN2014/070242

§ 371 Date: Jan. 29, 2014

(30) Foreign Application Priority Data
Dec. 27, 2013 (CN) 201310740358.3

(51) Int. Cl. B08B 3/02; B08B 3/04

(52) U.S. Cl. CPC B08B 3/022; B08B 3/041

(57) ABSTRACT

The substrate cleaning device provided in the present disclosure includes a cleaning room having an entrance and an exit, wherein the cleaning room is provided with a first cleaning assembly, a second cleaning assembly, and a third transporting device for transporting the substrate to the exit from the entrance; the first cleaning assembly and the second cleaning assembly are respectively arranged above and below the transporting device; the first cleaning assembly and the second cleaning assembly respectively include a plurality of nozzles arranged along a transporting direction of the substrate, and an ejection direction of each of the nozzles and the transporting direction of the substrate form an included angle greater than or less than 90 degrees. The substrate cleaning device can improve the ability to clean the substrate and thus improve the yield rate of the product and save the time required for cleaning the substrate.

### BACKGROUND

1. Technical Field

The present disclosure generally relates to technologies of liquid displays, and more particularly, to a substrate cleaning device.

2. Description of Related Art

During the manufacturing process of a thin film transistor liquid crystal display, a substrate is often cleaned before a filming process of the substrate begins to improve a performance and a yield rate of the product. Particles on the substrate are removed via water flow impinged on a surface of the substrate and thus the surface of the substrate is cleaned. In the traditional cleaning process, a nozzle of a cleaning machine faces towards the surface of the substrate, that is, an ejection direction of the nozzle is perpendicular to the surface of the substrate. Most of impurities on the substrate except some small stubborn particles can be removed when the substrate is cleaned in the way. The small stubborn particles not only reduce the performance and the yield rate of the product but also cause a secondary pollution by entering the next process together with the substrate.

### SUMMARY

The main object of the present disclosure is to provide a substrate cleaning device, for improving the ability to clean the substrate and thus improving the yield rate of the product and saving the time required for cleaning the substrate.

The substrate cleaning device provided in the present disclosure includes a cleaning room having an entrance and an exit, wherein the cleaning room is provided with a first cleaning assembly, a second cleaning assembly, and a third transporting device for transporting the substrate to the exit from the entrance; the first cleaning assembly and the second cleaning assembly are respectively arranged above and below the transporting device; the first cleaning assembly and the second cleaning assembly respectively include a plurality of nozzles arranged along a transporting direction of the substrate, and an ejection direction of each of the nozzles and the transporting direction of the substrate form an included angle greater than or less than 90 degrees.

Preferably, the first cleaning assembly and/ or the second cleaning assembly include at least one overlapping nozzle group, and each overlapping group include at least two of the nozzles having ejection areas thereof on the substrate at least partially overlapping each other.

Preferably, every two nozzles of the first cleaning assembly and/or the second cleaning assembly are divided into one group along a direction extending from the entrance to the exit, and ejection areas of the two nozzles of each group at least partially overlap each other.

Preferably, a single nozzle is arranged between two adjacent groups, and an ejection direction of the single nozzle and the transporting direction of the substrate form an acute angle with opening thereof facing the exit.

Preferably, at least one vice nozzle is arranged above and/or below the transporting device at a position adjacent to the exit, the ejection direction of the at least one vice nozzle and the transporting direction of the substrate form an acute angle with an opening thereof facing the exit.

Preferably, each of the nozzles of the first cleaning assembly and/or the second cleaning assembly is rotatable.

Preferably, the transporting device includes a plurality of spaced and parallel shafts arranged along a direction extending from the entrance of the cleaning room to the exit of the cleaning room, and an ejection area of each of the nozzles of the second cleaning assembly staggers a position of the corresponding shaft.

Preferably, a controlling valve is configured in each of the nozzles for controlling an ejection flow of the nozzle.

Preferably, the substrate cleaning device further includes a controlling device electrically connected to the controlling valve.

In the substrate cleaning device provided in the present disclosure, the nozzles of the first cleaning assembly or the second cleaning assembly are arranged along the transporting direction of the substrate, and the included angle formed between the ejection direction of each nozzle and the transporting direction of the substrate is greater than or less than degrees, causing the fluid ejected from the nozzle to be inclined relative to the particle on the surface of the substrate. Thus, the particle on the surface of the substrate can be flushed away under a relative small force to improve the ability to clean the substrate and the yield rate of the product and to save the time required for cleaning the substrate.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view of a substrate cleaning device in accordance with an embodiment of the present disclosure;

FIG. 2 is a schematic view of a substrate cleaning device in accordance with another embodiment of the present disclosure;

FIG. 3 is a schematic view showing a first state of a process that the substrate cleaning device cleans a particle on the substrate;

FIG. 4 is a schematic view showing a second state of the process that the substrate cleaning device cleans the particle on the substrate; and

FIG. 5 is a schematic view showing a third state of the process that the substrate cleaning device cleans the particle on the substrate.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

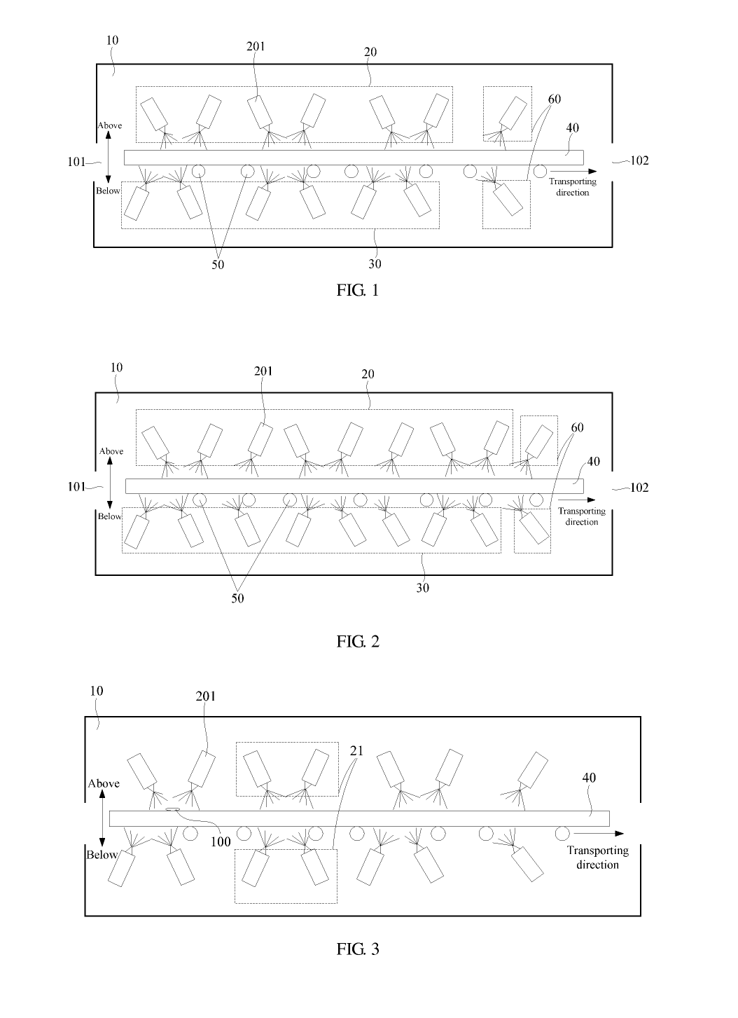

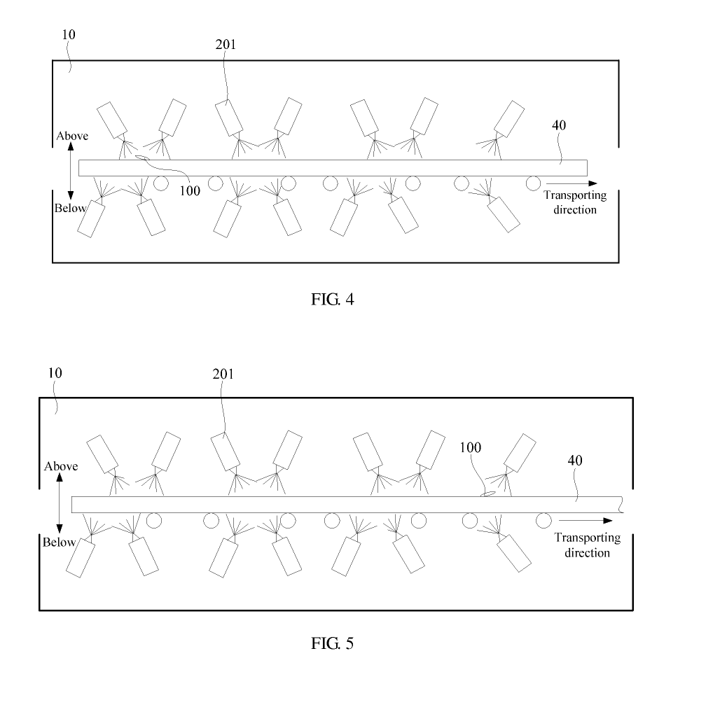

Referring to FIGS. 1 to 5, in which FIG. 1 is a schematic view of a substrate cleaning device in accordance with an embodiment of the present disclosure; FIG. 2 is a schematic view of a substrate cleaning device in accordance with another embodiment of the present disclosure; FIG. 3 is a schematic view showing a first state of a process that the substrate cleaning device cleans a particle on the substrate; FIG. 4 is a schematic view showing a second state of the process that the substrate cleaning device cleans the particle on the substrate; and FIG. 5 is a schematic view showing a third state of the process that the substrate cleaning device cleans the particle on the substrate.

The substrate cleaning device provided in the present disclosure, referring to FIGS. 1 to 5, includes a cleaning room 10 having an entrance 101 and an exit 102. The cleaning room 10 is provided with a first cleaning assembly 20, a second cleaning assembly 30, and a transporting device 50 for transporting a substrate 40 to the exit 102 from the entrance 101. The first cleaning assembly 20 and the second cleaning assembly 30 are respectively arranged above and below the transporting device 50. The first cleaning assembly 20 and the second cleaning assembly 30 respectively include a plurality of nozzles 201. The nozzles 201 of each cleaning assembly are arranged along the transporting direction of the substrate 40, and an included angle greater than or less than 90 degrees is formed between an ejection direction of each nozzle 201 and the transporting direction of the substrate 40. In the embodiment, the transporting direction of the substrate is parallel with the horizontal direction, and each nozzle 201 can be a nozzle with one single orifice or a mother-son nozzle with multiple orifices. In the embodiment, the nozzle 201 is a nozzle with one orifice. It is noted that in other embodiments, the nozzle 201 can be chosen according to actual requirements. Since the included angle formed between the ejection direction of the nozzle 201 and the transporting direction of the substrate 40 is greater than or less than 90 degrees, water flow or cleaning fluid ejected from the nozzle 201 can flush one side or two sides of a particle 100 on the surface of the substrate 40. In this way, when the water flow or cleaning fluid flushes the particle 100, the water flow or cleaning fluid can move the particle 100 to raise one side or two sides of the particle 100, making the particle 100 fall off. The process is just like moving an object with a spade. After the spade is inserted into one end of the object, the object can be moved under a minimum force. In addition, an ejection pressure of the nozzle 201 should be taken into consideration in the configuration of the substrate cleaning device. The ejection pressure of the nozzle 201 of the second cleaning assembly 30 should be less than or equal to the ejection pressure of the nozzle 201 of the first cleaning assembly 20, to prevent the ejection pressure of the nozzle 201 of the second cleaning device 30 from flushing the substrate 40 away from the transporting device 50 and further causing the displacement or falling off of the substrate 40.

In the substrate cleaning device provided in the present disclosure, the nozzles 201 of the first cleaning assembly 20 or the second cleaning assembly 30 are arranged along the transporting direction of the substrate 40, and the included angle formed between the ejection direction of each nozzle and the transporting direction of the substrate 40 is greater than or less than 90 degrees, causing the fluid ejected from the nozzle 201 to be inclined relative to the particle 100 on the surface of the substrate. Thus, the particle 100 on the surface of the substrate 40 can be flushed away under a relative small force to improve the ability to clean the substrate 40 and the yield rate of the product and to save the time required for cleaning the substrate 40.

Furthermore, referring to FIGS. 1 to 3, in order to improve the ability of removing the particle 100 on the substrate 40, the first cleaning assembly 20 and/ or the second cleaning assembly 30 include at least one overlapping nozzle group 21. Each overlapping nozzle group 21 includes at least two of the nozzles 201 with ejection areas thereof at least partially overlapping each other. In the embodiment, the number of the overlapping nozzle group 21 can be one or more. The ability of the substrate cleaning device to remove the particle 100 on the substrate 40 correspondingly becomes stronger as the number of the overlapping nozzle group 21 increases. The ejection areas of the at least two nozzles 201 of each overlapping nozzle group 21 at least partially overlap each other to ensure that two sides of the particles 100 on the substrate 40 can be flushed by the water flow or the cleaning fluid, which allows the particle 100 to fall off easily. In this way, the ability to clean the substrate 40 is improved and the time required for cleaning the substrate is saved.

In addition, referring to FIGS. 1 and 3, in another embodiment, every two of the nozzles 201 of the first cleaning assembly 20 or the second cleaning assembly 30 are divided into one group along the direction extending from the entrance 101 of the cleaning room 10 to the exit 102, and the ejection areas of the two nozzles 201 of each group at least partially overlap each other. There are three detailed ways to realize the embodiment: in a first one, every two nozzles 201 of the first cleaning assembly 20 are divided into one group along the direction extending from the entrance 101 to the exit 102; in a second one, every two nozzles 201 of the second cleaning assembly 30 are divided into one group along the direction extending from the entrance 101 to the exit 102; and in a third one, every two nozzles 201 of both the first cleaning assembly 20 and the second cleaning assembly 30 are divided into one group along the direction extending from the entrance 101 to the exit 102. In the embodiment, every two nozzles 201 are divided into one group along the direction extending from the entrance 101 to the exit 102, and the ejection areas of the two nozzles 201 of each group at least partially overlap each other, thus, the two nozzles 201 of each group can respectively flush two sides of the particle 100 on the substrate 40 to improve the continuity and the strengthen of the flushing operation. Therefore, the cleaning strength of the substrate 40 is improved to allow the substrate to be much cleaner.

Furthermore, referring to FIGS. 1 to 5, in order to flush away the loosened particle 100 on the substrate 100, a single nozzle 201 is arranged between two adjacent groups of above nozzles. The ejection direction of the single nozzle 201 and the transporting direction of the substrate 40 form an acute angle with an opening thereof facing the exit 102. In the embodiment, after the nozzles of each group move the particle 100 on the substrate 40, the single nozzle 201 flushes the loosened particle 100 towards the entrance 101 of the cleaning room 10, thereby flushing away the loosened particle 100 in time to prevent the loosened particle 100 from staying on the substrate 40.

Furthermore, referring to FIGS. 1 to 5, at least one vice nozzle 60 is provided above and/or below the transporting device 50 at a position adjacent to the exit 102. An ejection direction of the vice nozzle 60 and the transporting direction of the substrate 40 form an acute angle with an opening thereof facing the exit 102. In the embodiment, the vice nozzle 60 faces the entrance 101 of the cleaning room 10, thus, the loosened particle 100 on the substrate 40 is flushed towards one side of the substrate 40 adjacent to the entrance 101 of the cleaning room 10, which prevents the particle 100 on the substrate 40 and used cleaning water flow from entering the next process through the exit 102 of the cleaning room 10.

Furthermore, referring to FIGS. 1 to 2, each nozzle 201 of the first cleaning assembly 20 and/ or the second cleaning assembly 30 is configured to be rotatable for easy adjustment of the angle of the nozzle 201. A rotatable holder or a fixed holder can be arranged in the cleaning room to be connected to the nozzle 201.

Furthermore, the transporting device 50 includes a plurality of rotatable shafts. The rotatable shafts are arranged along the direction extending from the entrance 101 to the exit 102, being spaced from each other and parallel with each other. The ejection area of each nozzle 201 of the second cleaning assembly 30 on the substrate staggers the corresponding shaft. In the embodiment, each nozzle 201 of the second cleaning assembly 30 corresponds to the area between two corresponding adjacent shafts to prevent the transporting device 50 from blocking the water flow ejected from the nozzle 201.

Furthermore, referring to FIGS. 1 and 2, in order to improve the control of the flow of each nozzle 201 and save the cost while cleaning the substrate, a controlling valve (not shown) is provided within each nozzle 201 for controlling the flow thereof. The controlling valve can be a manual valve or an electromagnetic valve capable of adjusting the flow of the fluid ejected from the nozzle 201.

Furthermore, referring to FIGS. 1 and 2, the substrate cleaning device can further include a controlling device (not shown) electrically connected to the controlling valve. The controlling device is a main controller of the substrate cleaning device realized by using a MCU or other chips. When an electromagnetic valve is used as the controlling valve, the controlling device can control the time and flow accurately, thereby saving the cleaning cost while cleaning the substrate under the control of the controlling device. It is noted that the controlling device can further be used for controlling the operation of the transporting device 50.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A substrate cleaning device, comprising a cleaning room having an entrance and an exit, wherein the cleaning room is provided with a first cleaning assembly, a second cleaning assembly, and a third transporting device for transporting the substrate to the exit from the entrance; the first cleaning assembly and the second cleaning assembly are respectively arranged above and below the transporting device; the first cleaning assembly and the second cleaning assembly respectively comprise a plurality of nozzles arranged along a transporting direction of the substrate, and an ejection direction of each of the nozzles and the transporting direction of the substrate form an included angle greater than or less than 90 degrees.

2. The substrate cleaning device of claim 1, wherein at least one vice nozzle is arranged above and/ or below the transporting device at a position adjacent to the exit, and an ejection direction of the at least one vice nozzle and the transporting direction of the substrate form an acute angle with an opening thereof facing the exit.

3. The substrate cleaning device of claim 2, wherein each of the nozzles of the first cleaning assembly and/ or the second cleaning assembly is rotatable.

4. The substrate cleaning device of claim 2, wherein the transporting device comprises a plurality of spaced and parallel shafts arranged along a direction extending from the entrance of the cleaning room to the exit of the cleaning room, and an ejection area of each of the nozzles of the second cleaning assembly staggers a position of the corresponding shaft.

5. The substrate cleaning device of claim 2, wherein a controlling valve is provided within each of the nozzles for controlling an ejection flow of the nozzle.

6. The substrate cleaning device of claim 5 further comprising a controlling device electrically connected to the controlling valve.

7. The substrate cleaning device of claim 1, wherein the first cleaning assembly and/or the second cleaning assembly comprise at least one overlapping nozzle group, and each overlapping group comprises at least two of the nozzles having ejection areas thereof on the substrate at least partially overlapping each other.

8. The substrate cleaning device of claim 7, wherein at least one vice nozzle is arranged above and/ or below of the transporting device at a position adjacent to the exit, and an ejection direction of the at least one vice nozzle and the transporting direction of the substrate form an acute angle with an opening thereof facing the exit.

9. The substrate cleaning device of claim 8, wherein each of the nozzles of the first cleaning assembly and/ or the second cleaning assembly is rotatable.

10. The substrate cleaning device of claim 8, wherein the transporting device comprises a plurality of spaced and parallel shafts arranged along a direction extending from the entrance of the cleaning room to the exit of the cleaning room, and an ejection area of each of the nozzles of the second cleaning assembly staggers a position of the corresponding shaft.

11. The substrate cleaning device of claim 8, wherein a controlling valve is configured in each of the nozzles for controlling an ejection flow of the nozzle.

12. The substrate cleaning device of claim 11, wherein the substrate cleaning device further comprises a controlling device electrically connected to the controlling valve.

13. The substrate cleaning device of claim 1, wherein every two nozzles of the first cleaning assembly and/ or the second cleaning assembly are divided into one group along a direction extending from the entrance to the exit, and ejection areas of the two nozzles of each group at least partially overlap each other.

14. The substrate cleaning device of claim 13, wherein a single nozzle is arranged between two adjacent groups, and an ejection direction of the single nozzle and the transporting direction of the substrate form an acute angle with opening thereof facing the exit.

15. The substrate cleaning device of claim 14, wherein at least one vice nozzle is arranged above and/ or below the transporting device at a position adjacent to the exit, and the ejection direction of the at least one vice nozzle and the transporting direction of the substrate form an acute angle with an opening thereof facing the exit.

16. The substrate cleaning device of claim 13, wherein at least one vice nozzle is arranged above and/ or below the transporting device at a position adjacent to the exit, and the ejection direction of the at least one vice nozzle and the transporting direction of the substrate form an acute angle with an opening thereof facing the exit.

17. The substrate cleaning device of claim 16, wherein each of the nozzles of the first cleaning assembly and/ or the second cleaning assembly is rotatable.

18. The substrate cleaning device of claim 16, wherein the transporting device comprises a plurality of spaced and parallel shafts arranged along a direction extending from the entrance of the cleaning room to the exit of the cleaning room, and an ejection area of each of the nozzles of the second cleaning assembly staggers a position of the corresponding shaft.

19. The substrate cleaning device of claim 16, wherein a controlling valve is configured in each of the nozzles for controlling an ejection flow of the nozzle.

20. The substrate cleaning device of claim 19 further comprising a controlling device electrically connected to the controlling valve.
